(19) United States
(12) Patent Application Publication
(10) Pub. No.: US 2016/0247321 A1
(43) Pub. Date: Aug. 25, 2016

(54) Head Up Display System

(71) Applicant: Syndiant Inc., Dallas, TX (US)

(72) Inventors: Chun Chiu Daniel Wong, Dallas, TX (US); Po Wing Cheng, Dallas, TX (US)

(21) Appl. No.: 14/715,661

(22) Filed: May 19, 2015

(30) Foreign Application Priority Data
Feb. 24, 2015 (TW) 104105807

(51) Int. Cl. G06T 19/00; G02B 27/01; B60K 35/00; G06F 3/01

(52) U.S. Cl. CPC G06T 19/006; G06F 3/017; G02B 27/0101; B60K 35/00; B60K 2350/2052

(57) ABSTRACT

A head up display system comprises an optical projector, a projection screen, a combiner, a driver system board, an event data recorder, a front image sensor and a rear image sensor. The optical projector is a front projector or a rear projector for projecting the image onto the projection screen. Then the combiner projects a virtual image from the image of the projection screen within two to three meters behind the combiner and thus, drivers are able to observe the environment outside the car and to read the information provided by the head up display system simultaneously. The driver system board can connect to a driver's smart phone through wire (such as HDMI/MHL) or wireless (such as WiFi) and thus, an image from real-time contents of the smart phone or an image from other functions of the smart phone can be transmitted to the driver system board and projected by the optical projector for drivers' watch or use. The event data recorder and the front image sensor can record the driving information and traffic information and save them into a built-in memory or a Secure Digital Memory Card. The front image sensor can record the brightness outside a car so that a luminous flux of the optical projector can be adjusted automatically through the driver system board and thus, drivers are able to watch the images clearly on the head up display system under any circumstances. Meanwhile the event data recorder and the rear image sensor can record driving information and inside information and save them into a built-in memory or a Secure Digital Memory Card. The rear image sensor supports finger movement sensing technology to input instructions without finger contact or touch, and the inputted instructions will be transmitted to the driver's smart phone after being processed by the driver system board so as to operate the smart phone.

This application claims priority to Taiwan Patent Application No. 104105807 filed on Feb. 24, 2015.

### CROSS-REFERENCES TO RELATED APPLICATIONS

Not applicable.

### BACKGROUND OF THE INVENTION

1. Field of the Invention

The present invention relates to a head up display system with a projector, particularly a head up display system comprising an optical projector using DLP, LCOS, LCD, LBS or MEMS as its display element, an event data recorder, a front image sensor and a rear image sensor, wherein the head up display system can operate with a smart phone interactively.

2. Descriptions of the Related Art

A head up display system in the prior art only projects some information such as engine speed, vehicle speed or mileage onto a car windshield in front of a driver based on optical principles. Drivers can receive the said information without lowering their heads down to search those information through such prior art. However the available information and functions are limited due to the limited information and functions offered by the head up display system in the prior art and thus, drivers still has to lower down their heads to search information needed or operate vehicle equipment. Therefore, it is desirable to provide a head up display system containing more useful functions so as to upgrade driving conditions and improve driving safety for drivers.

### SUMMARY OF THE INVENTION

To attain the above objectives, the present invention provides a head up display system, comprising an optical projector, a projection screen, a combiner, a driver system board, an event data recorder, a front image sensor and a rear image sensor. The optical projector uses DLP (Digital Light Processing), LCOS (Liquid Crystal on Silicon), LCD (Liquid Crystal Display), LBS (Laser Beam Steering) or MEMS (Micro Electro Mechanical Systems) as display elements and thus, having features of higher resolution and higher contrast so as to provide drivers with HD images effects, wherein the LCOS display element can be color-filter type or color sequential type. The projection screen and the combiner enable drivers to watch a virtual image within two to three meters away from the driver and thus incorporating the image with environment outside the car. Accordingly, the present invention provides a head up display system which can integrate relevant vehicle functional equipment so as to upgrade driving conditions and improve driving safety for drivers without lowering down their heads to operate those other vehicle equipment.

To further improve the functions of a head up display system and road safety, the present invention provides a driver with a head up display system which can operate with the driver's smart phone interactively. The system comprises a driving system board for generating and processing images, an optical projector for capturing images from the driver system board so as to provide drivers with an image from real-time contents of the smart phone or an image from other functions of the smart phone such as a GPS image, an event data recorder and a front image sensor for recording the driving information and traffic information and saving them into a built-in memory or a Secure Digital Memory Card. The front image sensor records the brightness outside a car so that a luminous flux of the optical projector can be adjusted automatically through the driver system board and thus, drivers are able to clearly watch images of the head up display system under any circumstances. The system can also comprise an event data recorder and a rear image sensor for recording driving information and inside information and saving them into a built-in memory or a Secure Digital Memory Card. The rear image sensor can support finger movement sensing technology to input instructions without finger contact or touch. The inputted instructions will be transmitted to the driver's smart phone after being processed by the driver system board and thus, the driver can operate the smart phone via finger movement sensing technology. Therefore, the present invention provides a head up display system connecting with a smart phone. The system can integrate relevant vehicle functional equipment so as to upgrade driving conditions and improve driving safety for drivers without lowering down their heads to operate those other vehicle equipment.

The detailed technology and preferred embodiments implemented for the subject invention are described in the following paragraphs accompanying the appended drawings for people skilled in this field to well appreciate the features of the claimed invention.

The above summary and following detailed description are exemplary for further explaining the claims of the subject invention. Other objectives and advantages will be further illustrated in the following description and graphs.

### BRIEF DESCRIPTION OF THE DRAWINGS

FIG. 1 is a diagram of a head up display system in accordance with an embodiment of the subject invention;

### DESCRIPTION OF THE PREFERRED EMBODIMENT

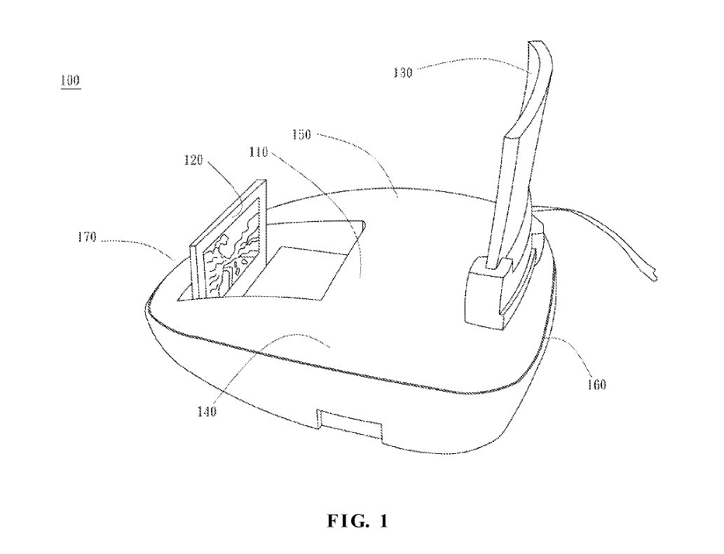

FIG. 1 is the front view of a head up display system 100 in accordance with an embodiment of the subject invention, comprising a driver system board 140 for generating an image, an optical projector 110 for capturing images from the driver system board 140 so as to provide drivers with necessary images and information. In addition, the system can also provide images and information retrieved from their smart phones by the drivers.

The optical projector 110 provides images with HD quality such as 720p, 1080i, 1080p and images with other different resolutions. The optical projector 110 uses DLP (Digital Light Processing), LCOS (Liquid Crystal on Silicon), LCD (Liquid Crystal Display), LBS (Laser Beam Steering) or MEMS (Micro Electro Mechanical Systems) as display elements and thus, having features of higher resolution and higher contrast so as to provide drivers with HD images effects, wherein the LCOS display element can be color-filter type or color sequential type. In addition, a LED illumination part in the optical projector can be red, green and blue LEDs, or white LEDs. Red, green and blue Laser Diodes can be the illumination part as well.

In this embodiment, the driver system board 140 can connect to a driver's smart phone through wire (including but not limited to HDMI/MHL interface) or wireless (including but not limited to WiFi or Bluetooth) and thus, an image from real-time contents of the smart phone or an image from other functions (including but not limited to GPS) of the smart phone can be transmitted to the driver system board 140 and projected by the optical projector 110. The driver system board 140 can output a single image or multiple images to the optical projector 110. The single image can be internal image which is stored or downloaded by the driver system board 140, integrated image which integrates the external image and the internal image. Multiple images can be Picture by Picture (PBP), Picture in Picture (PIP) or Picture out Picture (POP). In addition, the driver system board 140 can further comprise a function of a multimedia player.

In this embodiment, the present invention comprises a projection screen 120 and a combiner 130. The optical projector 110 can be a front projector or a rear projector for projecting the image onto the projection screen 120. Then the combiner 130 projects a virtual image from the image of the projection screen 120 within two to three meters behind the combiner and thus, the drivers can observe environment outside the car and read the information provided by the head up display system simultaneously. The combiner 130 can be substituted by a car windshield. The system can be installed on a car sunshade or a car dashboard.

In this embodiment, the present invention comprises an event data recorder 150 and a front image sensor 160 for recording the driving information and traffic information and saving them into a built-in memory or a Secure Digital Memory Card.

In this embodiment, the present invention comprises a front image sensor 160 for recording the brightness outside a car so that a luminous flux of the optical projector can be adjusted automatically through the driver system board 140 and thus, drivers are able to watch the images clearly on the head up display system under any circumstances.

In this embodiment, the present invention comprises an event data recorder 150 and a rear image sensor 170 for recording driving information and inside information and saving them into a built-in memory or a Secure Digital Memory Card.

In this embodiment, the present invention comprises a rear image sensor 170 supporting finger movement sensing technology to input instructions without finger contact or touch. The inputted instructions will be transmitted to the driver's smart phone after being processed by the driver system board 140 and thus, the driver can operate the smart phone via finger movement sensing technology.

The above disclosure is related to the detailed technical contents and inventive features thereof Persons skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A head up display system, comprising:
a driver system board for generating an image;
an optical projector, a projection screen and a combiner, wherein the optical projector captures the image from the driver system board and then projects the image onto the projection screen, and the combiner projects a virtual image from the image of the projection screen within two to three meters behind the combiner;
an event data recorder;
a front image sensor; and
a rear image sensor.

2. The head up display system of claim 1, wherein the optical projector uses DLP (Digital Light Processing), LCOS (Liquid Crystal on Silicon), LCD (Liquid Crystal Display), LBS (Laser Beam Steering) or MEMS (Micro Electro Mechanical Systems) as a display element of the optical projector.

3. The head up display system of claim 2, wherein the LCOS display element is color-filter type or color sequential type.

4. The head up display system of claim 1, wherein an illumination part of the optical projector can be red, green and blue LEDs, or white LEDs, or red, green and blue Laser Diodes.

5. The head up display system of claim 1, wherein the optical projector is a front projector or a rear projector for projecting the image onto the projection screen.

6. The head up display system of claim 1, wherein the combiner can be substituted by a car windshield.

7. The head up display system of claim 1, wherein the driver system board connects to a driver's smart phone through wire or wireless and thus, an image from real-time contents of the smart phone or an image from other functions of the smart phone can be transmitted to the driver system board and projected by the optical projector.

8. The head up display system of claim 6, wherein the image from other functions of the smart phone is a GPS image.

9. The head up display system of claim 1, wherein the driver system board further comprises a function of a multimedia player.

10. The head up display system of claim 1, wherein the driver system board outputs a single image or multiple images to the optical projector.

11. The head up display system of claim 1, wherein the event data recorder and the front image sensor can record the driving information and traffic information and save them into a built-in memory or a Secure Digital Memory Card.

12. The head up display system of claim 1, wherein the front image sensor records the brightness outside a car so that a luminous flux of the optical projector can be adjusted automatically through the driver system board.

13. The head up display system of claim 1, wherein the event data recorder and the rear image sensor record driving information and inside information and save them into a built-in memory or a Secure Digital Memory Card.

14. The head up display system of claim 7, wherein the rear image sensor supports finger movement sensing technology to input instructions without finger contact or touch, and the inputted instructions are transmitted to the driver's smart phone after being processed by the driver system board so as to operate the smart phone.

15. The head up display system of claim 1, wherein the system can be installed on a car sunshade or a car dashboard.
